(19) United States
(12) Patent Application Publication
(10) Pub. No.: US 2012/0064833 A1
(43) Pub. Date: Mar. 15, 2012

(54) WIRELESS COMMUNICATION SYSTEM AND WIRELESS COMMUNICATION DEVICE

(76) Inventors: Hiroshi Nakano, Osaka (JP); Takashi Onodera, Osaka (JP); Kozue Hirata, Osaka (JP); Minoru Kubota, Osaka (JP)

(21) Appl. No.: 13/321,194

(22) PCT Filed: May 19, 2010
(86) PCT No.: PCT/JP2010/058414

§ 371 Date: Nov. 18, 2011

(30) Foreign Application Priority Data
May 21, 2009 (JP) 2009-123063

(51) Int. Cl. H04B 15/00; H04B 7/24

(52) U.S. Cl. 455/63.1; 455/39

(57) ABSTRACT

When applying inflated lattice precoding (ILP) transmission to a multi-carrier scheme, there arises a need to notify coefficient α thereof per sub-carrier. Applying ILP transmission has proven difficult since multi-carrier schemes such as those widely adopted in mobile communication systems, etc., in recent years have an extremely large number of sub-carriers and the information volume of the control signal becomes extremely large. As such, at a transmitter device B, coefficient α is inputted to a 1/α multiplier part 15, and a DRS from a dedicated reference signal (DRS) generator part 11 is multiplied by 1/α and transmitted. At a receiver device C, an estimated signal is obtained by performing a remainder process at a reception modulo operator part 51 using a modulo width determined based on the DRS, without performing a process of a reception coefficient multiplier part with respect to a reception signal.

### TECHNICAL FIELD

The present invention relates to a wireless communication system and a wireless communication device, and to an interference-suppressed wireless communication system and interference-suppressed wireless communication device which perform wireless communication with interference suppressed.

### BACKGROUND ART

With respect to communication systems, if a transmitter device is able to know in advance the interference signal component contained in the reception signal of a receiver device, it is possible to have the receiver device be substantially unaffected by interference by subtracting (cancelling) the interference signal component from the transmission signal at the transmitter device in advance.

However, there was a problem with thus subtracting the interference signal component from the transmission signal in that the transmission power would increase with the interference signal power. In order to solve this problem, there has been proposed a method referred to as Tomlinson-Harashima Precoding (THP) which is capable of suppressing the increase in transmission power by performing a modulo (remainder) operation on a communication signal at both the transmitter and receiver devices (see Non-Patent Document 1 mentioned below).

Further, there has been proposed a method referred to as Inflated Lattice Precoding (ILP), which, as compared to when THP is simply used, is capable of improving error rate characteristics by, in performing communications using THP, multiplying the interference signal component to be subtracted from the transmission signal at the transmitter device by an appropriate coefficient α (0<α≦1) to transmit the interference signal component without completely canceling it, and multiplying the reception signal with the same coefficient α at the receiver device as well (see Non-Patent Document 2 mentioned below).

FIG. 4 is a schematic diagram showing a signal flow with respect to a wireless communication system X that uses conventional ILP. In FIG. 4, desired signal s represents a signal that a transmitter device Y is to transmit to a receiver device Z (modulated symbols of transmission data), and estimated signal s′ represents an estimation result for desired signal s as derived by the receiver device Z from the reception signal. In addition, interference signal f represents an interference signal received at the receiver device Z as included in the reception signal, and it is assumed that this interference signal f is known to the transmitter device Y in advance.

For purposes of brevity, a description will now be provided assuming the propagation channel between the transmitter device Y and the receiver device Z is an additive white Gaussian noise (AWGN) channel.

At the transmitter device Y, known interference signal f is first multiplied by coefficient α at a transmission coefficient multiplier part 101, and αf is outputted. At an interference subtractor part 103, this interference signal αf that has been multiplied by α is subtracted from desired signal s, and (s−αf) is outputted.

At a transmission modulo operator part 105, a modulo operation (Mod_{τ}) with a modulo width of r is performed with respect to (s−αf), and Modᵣ(s−αf) is outputted. Here, modulo operation Mod_{τ}(υ) for a given complex vector, 1), is represented by Equation (1) below. It is noted that j represents an imaginary unit, and floor (a) the largest integer not exceeding a, and that Re(υ) and Im(υ) respectively represent the real part (corresponding to the in-phase component of a signal) and imaginary part (corresponding to the quadrature component of a signal) of complex number υ.

$$\begin{matrix}[ Eq . 1 ] & \\ {Mod}_{τ} ( v ) = v - floor ( \frac{Re ( v ) + \frac{τ}{2}}{τ} ) τ - j \cdot floor ( \frac{Im ( v ) + \frac{τ}{2}}{τ} ) τ & ( 1 )\end{matrix}$$

At a wireless transmitter part 107, the result of the modulo operation, Mod_{τ}(s−αf), is transmitted from a transmit antenna 111 as transmission signal x. At the receiver device Z, a wireless receiver part 115 first receives reception signal y (=x+f+n) in which interference signal f is added to transmission signal x and noise n is further added thereto. A reception coefficient multiplier part 117 multiplies reception signal y by the same coefficient α as that by which interference signal f was multiplied at the transmission coefficient multiplier part 101 of the transmitter device Y, and outputs αy.

Using modulo width τ′, which is such that its ratio with respect to the Euclidean distance of estimated signal s′ would be the same as the ratio of the Euclidean distance of desired signal s to modulo width τ of the transmission modulo operator part 105 at the transmitter device Y, a reception modulo operator part 121 performs a modulo operation (Mode), and outputs estimated signal s′ Mod_{τ′}(τy)).

Here, by determining coefficient α as in Equation (2), the error between desired signal and estimated signal s′ may be minimized, and, as compared to when THP is simply used (equivalent to α=1 with respect to ILP), error rate characteristics may be improved (Non-Patent Document 2 mentioned below). It is noted that σₓ² represents the variance of transmission signal x, and σₙ² the variance of noise n. σₓ²/σₙ² is equivalent to the signal to noise power ratio (SNR).

$$\begin{matrix}[ Eq . 2 ] & \\ α = \frac{{σ}_{x}^{2}}{{σ}_{n}^{2} + {σ}_{x}^{2}} = \frac{SNR}{1 + SNR} & ( 2 )\end{matrix}$$

FIG. 5 is a diagram showing an example of the structure of a downlink transmission frame with respect to a conventional communication system that performs ILP transmission. The transmission frame comprises a common reference signal (CRS) 131, a control signal (Control CHannel: CCH) 133, a dedicated reference signal (DRS) 135, and data (Shared Data CHannel: SCH) 137.

FIG. 6 is a schematic diagram showing a signal flow with respect to a conventional wireless communication system X′ that performs ILP transmission, and the signal flow is described using this figure.

A transmitter device Y′ is such that, based on the SNR reported from a receiver device Z′, a coefficient α determining part determines coefficient α based on Equation (2), and inputs it to a CCH generator part 217 and a transmission coefficient multiplier part 201. An MCS (Modulation and Channel coding Scheme) determining part 227 determines the modulation scheme and the code rate. A CRS, which serves as a reference for demodulating CCH, is generated at a CRS generator part 222. A control signal, which includes coefficient α along with other control information, etc., is outputted at the CCH generator part 217. A DRS generator part 211 generates a signal of a specified phase and amplitude. An SCH generator part 207 performs a process of ILP transmission of up to wireless transmitter part input of the transmitter device Y′ shown in FIG. 6 and generates an SCH signal. Each signal is sent to a frame structuring part 231, and a transmission frame is generated. The transmission frame is transmitted on a downlink via a wireless part 233. When the MCS is altered, modulation is performed at the SCH generator part 207 based on MCS information, and a modulo operation is performed with modulo width τ that is appropriate for the modulation. However, the signal flow is omitted in FIG. 6.

On the other hand, at the receiver device Z′, via a wireless receiver part 243, a frame separator part 245 separates the frame The reference signal for demodulation is detected at a CRS detector part 257, and, based on that signal, a CCH demodulator part 255 demodulates coefficient α and such information as the MCS, etc. The CCH demodulator part 255 inputs coefficient α to a reception coefficient multiplier part 252. A reference signal that is used for SCH demodulation is detected at a DRS detector part 253, and propagation channel hs between the transmitter device and the receiver device is estimated. The DRS detector part 253 inputs estimated hs to a propagation channel compensation part 250. The propagation channel compensation part 250 performs propagation channel compensation with respect to the SCH signal. Based on the reference signal obtained at the DRS detector part 253, the process of ILP transmission of from the wireless receiver part of the receiver device and onward shown in FIG. 4 is performed at an SCH demodulator part 247. In addition, at the receiver device, SNR is estimated at an SNR measuring part 261 based on the signal obtained from the CRS detector part 257, and is transmitted to the transmitter device Y′ using the uplink.

TABLE 1

| Modulation Scheme | Power Increase | |
|---|---|---|
| QPSK | 4/3 | times |
| 16-QAM | 16/15 | times |
| 64-QAM | 64/63 | times |

Next, using FIG. 7, a conventional method of determining and notifying coefficient α is presented. When represented as constellation points of such modulation schemes as QPSK, QAM, etc., desired signal s and an SCH signal as processed by ILP differ in terms of the signal constellations of their transmission signals as shown in FIG. 7. Whereas the CRS is generally a QPSK signal, since interference is subtracted and a modulo operation is performed in ILP transmission, it becomes a signal that is distributed within a square in a phase plane. Depending on the modulation scheme, such power increases as those in Table 1 occur. The SNR reported from the receiver device is a measurement value based on the CRS signal. However, based on the MCS from the MCS determining part 227, the coefficient α determining part 225 (FIG. 6) reads out a value from a power increase storage part 223 storing the above-mentioned power increases caused by ILP, and determines coefficient α while taking SNR improvement amounts in ILP transmission into account. Coefficient α is inputted to the CCH generator part 217 and is notified to the receiver device Z′ along with other control signals, while on the other hand being used for SCH generation at the SCH generator part 207. At the receiver device Z′, the SCH signal that has been transmitted by ILP is processed at the reception coefficient multiplier part 117 as shown in FIG. 4 using coefficient α demodulated at the CCH demodulator part 255.

### PRIOR ART DOCUMENTS

Non-Patent Documents
Non-Patent Document 1: Harashima et al., “Matched-Transmission Technique for Channels With Intersymbol Interference”, IEEE Transaction on Communications, Vol.COM-20, No. 4, p. 774-780, August 1972
Non-Patent Document 2: R. F. H. Fischer, “The Modulo-Lattice Channel: The Key Feature in Precoding Schemes”, AEU-Int. Journal of Electronics and Communications, p. 244-253, June 2005

### SUMMARY OF THE INVENTION

### Problems to be Solved by the Invention

When applying ILP transmission to a single-carrier scheme, methods in which coefficient α is transmitted using control signal CCH as discussed above do not pose a problem since the load related to the information volume of CCH is small. However, in the case of such multi-carrier schemes as OFDM (Orthogonal Frequency Division Multiplexing), since the attenuation amount with respect to the propagation channel varies from sub-carrier to sub-carrier, the SNR measured at the receiver device also varies from sub-carrier to sub-carrier. When applying ILP transmission to such a multi-carrier scheme, there arises a need to notify coefficient α per sub-carrier.

Applying ILP transmission has proven difficult since multi-carrier schemes such as those widely adopted in mobile communication systems, etc., in recent years have an extremely large number of sub-carriers and the information volume of the CCH becomes extremely large.

The present invention is made in view of such circumstances, and an object thereof lies in the provision of a communication system and communication device in which ILP transmission is performed without notifying coefficient α with the CCH.

### Means for Solving the Problems

According to one aspect of the present invention, there is provided a transmitter device in a wireless communication system in which a modulo operation is performed on a modulated signal at least one of the transmitter device and a receiver device, wherein an altered modulo width is notified by way of the amplitude of a portion of a transmission signal. It is preferable that a portion of the transmission signal be a portion, or the whole, of a DRS. It is preferable that the DRS be a DRS that is dedicated to a receiver device of an address included in the transmission signal.

With respect to the wireless communication system mentioned above, there is provided a transmitter device wherein the altered modulo width is notified using a reference amplitude of an altered DRS. In addition, it may also be a transmitter device that transmits to a receiver device a transmission signal generated by subtracting the result of multiplying an interference signal, which corresponds to interference that the receiver device is subjected to, by a coefficient and by further performing a modulo operation, and a DRS generated based on the coefficient. It is preferable that the DRS have an amplitude that is proportional to the inverse of the coefficient. It is preferable that the DRS be transmitted with its power attenuated by a predetermined power.

According to another aspect of the present invention, there is provided a receiver device that receives a transmission signal and a DRS that are transmitted by a transmitter device, performs propagation channel estimation using the received DRS, performs a modification in which a received power of the estimated propagation channel is held to be greater by a predetermined power, based on a result of the modified propagation channel estimation, performs propagation channel compensation with respect to the received transmission signal, and performs a modulo operation with respect to the received transmission signal that has undergone the propagation channel compensation.

In addition, there is provided a wireless communication system comprising: a transmitter device that transmits, to a receiver device, a transmission signal generated by subtracting the result of multiplying an interference signal, which corresponds to interference that the receiver device is subjected to, by a coefficient and by further performing a modulo operation, and an off-set reference signal in which a DRS generated based on the coefficient is attenuated by a predetermined power; and the receiver device that receives the transmission signal and the off-set reference signal, performs propagation channel estimation using the received off-set reference signal, performs a modification in which a received power of the estimated propagation channel is held to be greater by the predetermined power, based on a result of the modified propagation channel estimation, performs propagation channel compensation with respect to the received transmission signal, and performs a modulo operation with respect to the received transmission signal that has undergone the propagation channel compensation. It is preferable that the DRS have an amplitude that is proportional to the inverse of the coefficient.

In addition, the present invention may also be a transmitter device in a wireless communication system in which a modulo operation is performed with respect to a modulated signal at one or both of the transmitter device and a receiver device, the transmitter device comprising: a coefficient α determining part that determines a coefficient α; a DRS generator part that generates a DRS; a 1/α multiplier part that multiplies the DRS by the inverse of the coefficient α; and an SCH generator part that generates an ILP signal based on the coefficient α.

Further, it is preferable that the transmitter device further comprise an off-set adjustor part that attenuates the power of the DRS generated by the DRS generator part by a predetermined power.

In addition, the present invention may also be a receiver device comprising:

a wireless receiver part that receives a transmission signal and a DRS transmitted by a transmitter device; a DRS detector part that performs propagation channel estimation using the received DRS; an off-set modifier part that performs a modification in which a received power of the estimated propagation channel is held to be greater by a predetermined power; a propagation channel compensation part that performs propagation channel compensation with respect to the received transmission signal based on a result of the modified propagation channel estimation; and a reception modulo operator part that performs a modulo operation with respect to the received transmission signal that has undergone the propagation channel compensation.

At the receiver device, an estimated signal is obtained by performing a remainder process using a modulo width determined based on the DRS at the reception modulo operator part without performing the process at the reception coefficient multiplier part with respect to the reception signal.

The contents of the specification and/or drawings of JP Patent Application No. 2009-123063, from which the present application claims priority, are incorporated into the present specification.

### Effects of the Invention

With the present invention, transmission by ILP may be realized without notifying coefficient α through a control signal, and error rate characteristics may be improved.

### BRIEF DESCRIPTION OF THE DRAWINGS

FIG. 1A is a diagram showing the configuration of a communication system as a whole with respect to the first embodiment of the present invention.

FIG. 1B is a diagram showing a system configuration example in which, with respect to a system where a transmitter device transmits an OFDM signal and a receiver device receives the signal, a transmission signal from another communication device (interference source) is also received as interference.

FIG. 2 is a diagram showing a coefficient α determining and notifying method according to the present embodiment.

FIG. 3 is a schematic diagram showing a signal flow with respect to a wireless communication system according to the second embodiment of the present invention.

FIG. 4 is a schematic diagram showing a signal flow with respect to a wireless communication system X in which conventional ILP is used.

FIG. 5 is a diagram showing a downlink transmission frame structure example with respect to a conventional communication system that performs ILP transmission.

FIG. 6 is a diagram showing a conventional coefficient α determining and notifying method.

FIG. 7 is a diagram showing a conventional coefficient α determining and notifying method.

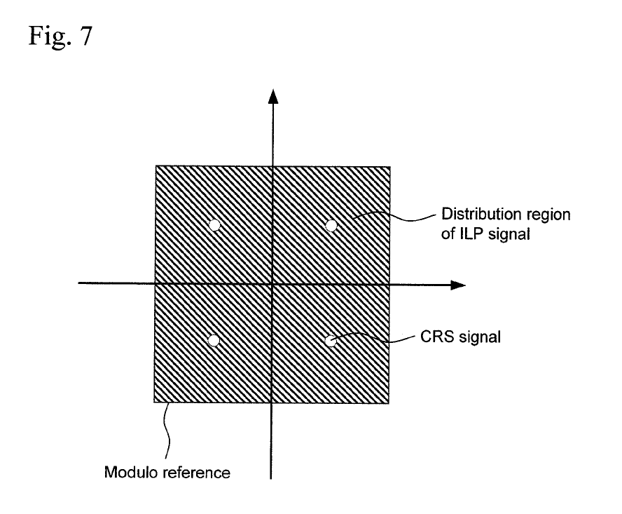

### LIST OF REFERENCE NUMERALS

A . . . wireless communication system, B′ . . . transmitter device, C′ . . . receiver device, 1 . . . transmission coefficient multiplier part, 3 . . . interference operation part, 5 . . . transmission modulo operator part, 7 . . . SCH generator part, 11 . . . DRS generator part, 15 . . . 1/α multiplier part, 17 . . . CCH generator part, 21 . . . CRS generator part, 23 . . . power increase storage part, 25 . . . coefficient α determining part, 27 . . . MCS determining part, 31 . . . frame structuring part, 33 . . . wireless transmitter part, 35 . . . transmit antenna, 41 . . . receive antenna, 43 . . . wireless receiver part, 45 . . . frame separator part, 47 . . . SCH demodulator part, 51 . . . reception modulo operator part, 53 . . . DRS detector part, 55 . . . CCH demodulator part, 57 . . . CRS detector part, 61 . . . SNR measuring part.

### MODES FOR CARRYING OUT THE INVENTION

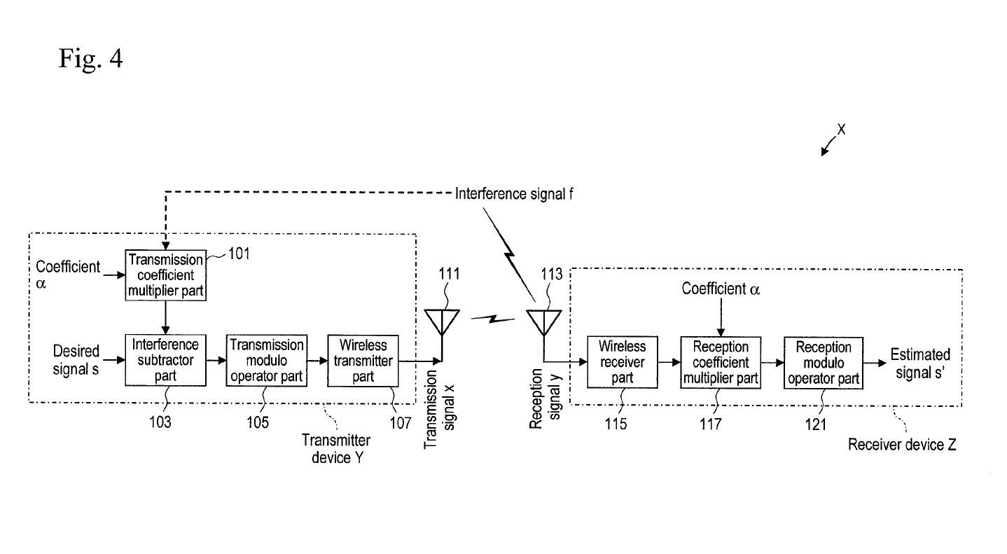

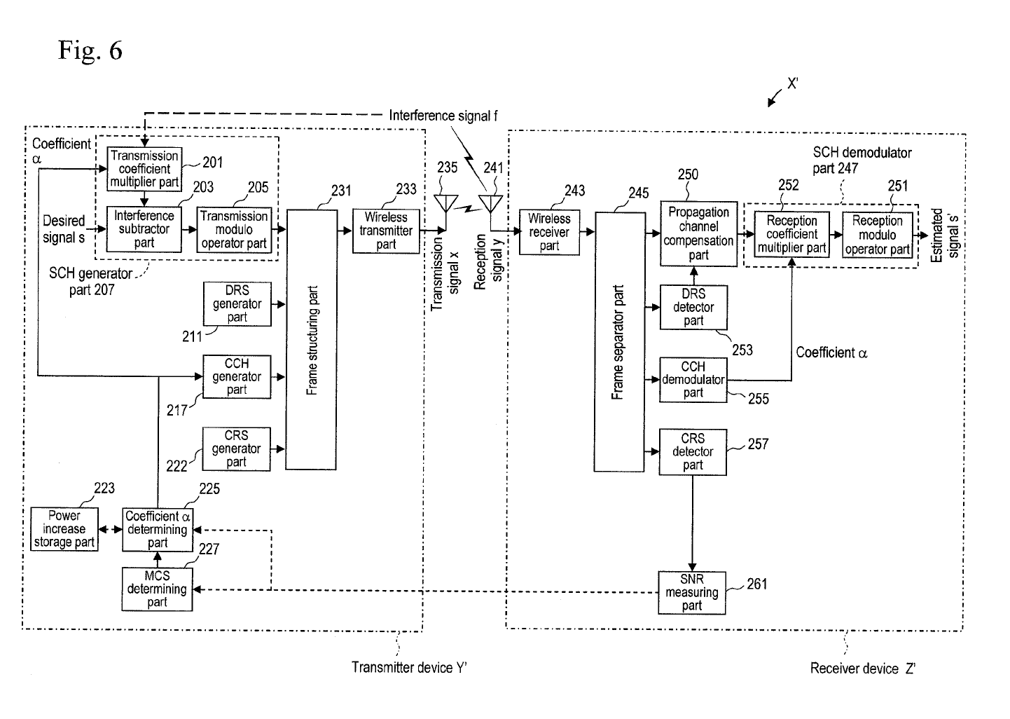

With respect to the present embodiments, the basic configurations are the configurations shown in FIGS. 4 and 6, and descriptions are provided below with regard to features that differ. Accordingly, they are similar to the descriptions above and incorporate the descriptions.

### First Embodiment

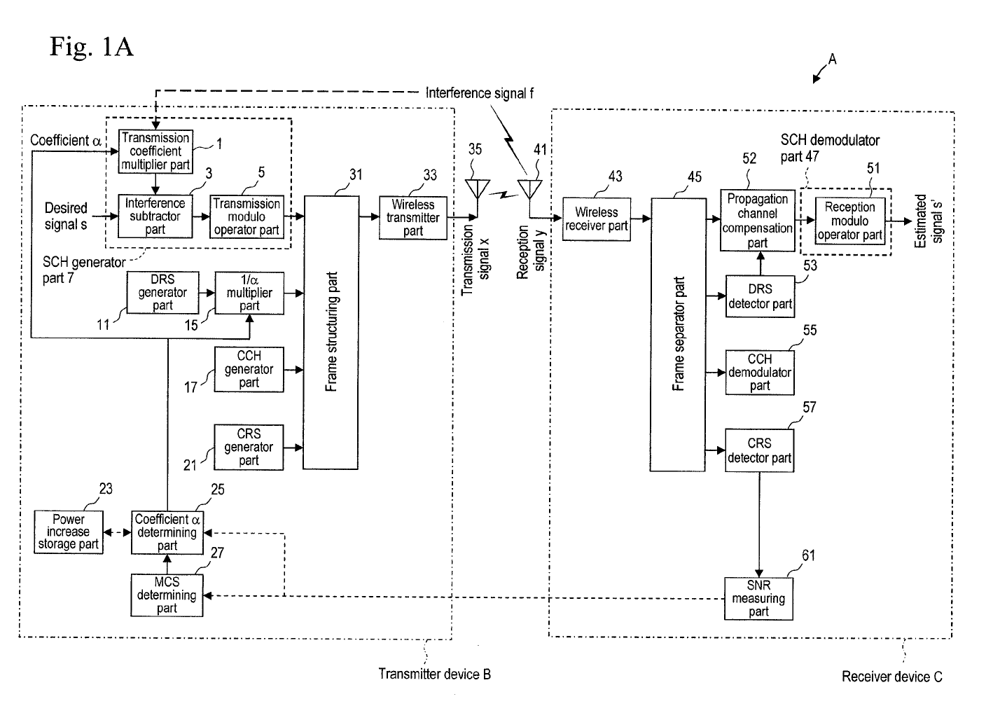

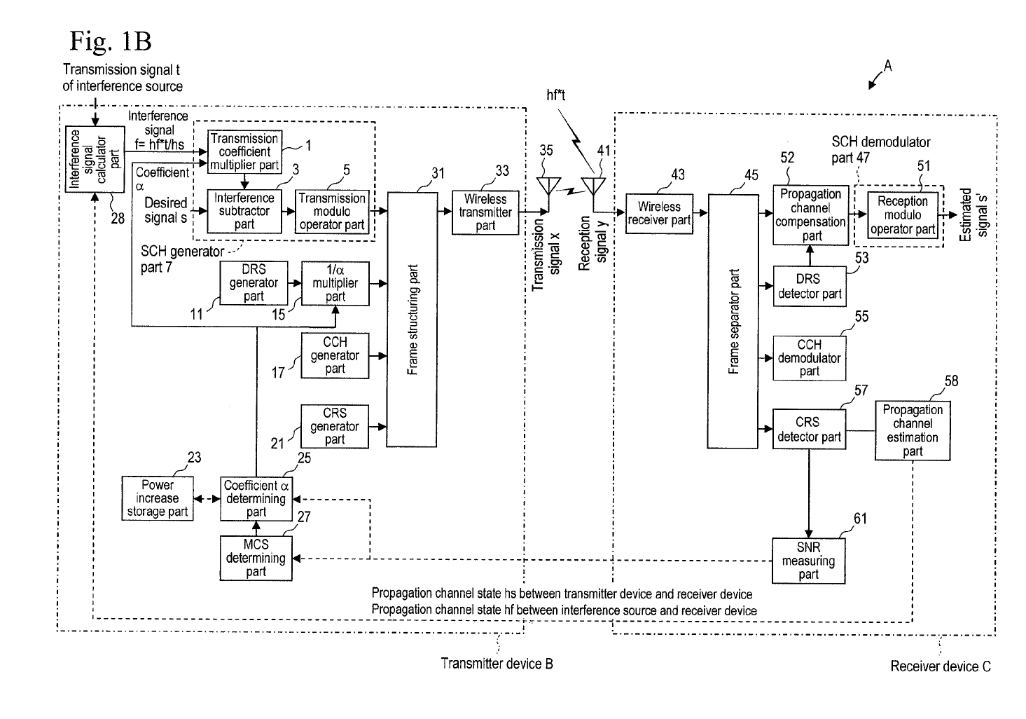

FIG. 1A is a schematic diagram showing a signal flow with respect to a wireless communication system according to an embodiment of the present invention. Features that differ from those in FIG. 6 are described below. Coefficient α determined by a coefficient α determining part 25 is inputted to a 1/α multiplier part 15, and a DRS from a DRS generator part 11 is multiplied by 1/α (the inverse of coefficient α) and inputted to a frame structuring part 31. In other words, an altered modulo width is notified to the receiver device side by means of the amplitude of a portion of the transmission signal. There is no need to input coefficient α to a CCH generator part 17 from the coefficient α determining part 25, and there is no need to include within the control signal the value of coefficient α.

Next, the process at the receiver device based on the DRS that has been multiplied by 1/α will be described. In FIG. 6, the propagation channel compensation part 250 performed propagation channel compensation with respect to the SCH signal outputted from the frame separator part 245, and the signal after propagation channel compensation was multiplied at the reception coefficient multiplier part by coefficient α notified from the CCH demodulator part 255, thereby reducing the SCH signal with respect to the modulo width that the subsequent reception modulo operator part 251 has.

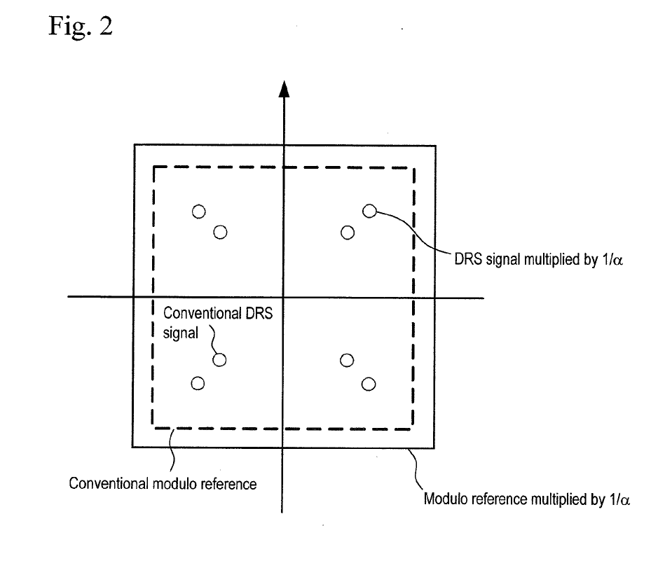

In the present embodiment, as shown in FIG. 2, the DRS is magnified to be 1/α times what is conventional, and an estimated signal may be obtained without performing the processes at the reception coefficient multiplier part by performing a remainder process using the modulo width determined based on the DRS at the reception modulo operator part. With respect to multi-carrier schemes, there are cases where DRS signals are inserted into sub-carriers only at certain intervals. However, methods in which the DRS closest with respect to the frequency axis is used, or in which the DRS for each sub-carrier is estimated based on neighboring DRS's and used are conceivable, and may be combined with a method according to the present embodiment.

According to the present embodiment, it is possible to realize transmission by ILP without notifying coefficient α through a control signal, and to improve error rate characteristics.

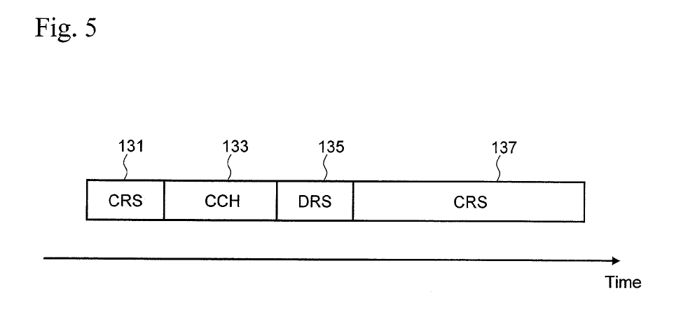

A process of the present embodiment will be described with reference to FIG. 1A. It is assumed that a transmitter device B, by way of example, transmits CRS, CCH, DRS and SCH signals in the order shown in FIG. 5. Using the CRS transmitted from the transmitter device B, a receiver device C measures the SNR at an SNR measuring part 61 and notifies the transmitter device B.

Next, the configuration of a transmitter device is presented. An MCS determining part 27 determines the MCS based on the SNR received from the receiver device C. Further, the determined MCS is inputted to the coefficient α determining part 25. Based on a power increase amount stored in a power increase storage part 23 and on the SNR notified from the receiver device C, the coefficient α determining part 25 determines coefficient α and inputs it to the 1/α multiplier part 15 and a transmission coefficient multiplier part 1. The transmission coefficient multiplier part 1 multiplies interference signal f by coefficient α, and inputs the multiplied signal, αf, to an interference subtractor part 3. The interference subtractor part 3 subtracts αf from desired signal s, which has been modulated by a method, such as QPSK, QAM, etc., and inputs s−αf as subtracted to a transmission modulo operator part 5. The transmission modulo operator part 5 performs a modulo operation on s−αf, and inputs the signal after the modulo operation to the frame structuring part 31.

In addition, the DRS generator part 11 generates a DRS and inputs it to the 1/α multiplier part 15. The 1/α multiplier part 15 multiplies the DRS by 1/α, and inputs the DRS that has been multiplied by 1/α to the frame structuring part 31. A CRS generator part 21 generates a CRS and inputs it to the frame structuring part 31. The frame structuring part 31 structures a frame using the inputted CRS, DRS and SCH signals x, and transmits the frame to the receiver device C as a wireless signal with a wireless transmitter part 33. It is noted that a portion of the transmission signal is a portion, or the whole, of the DRS. In addition, the DRS is a DRS that is dedicated to the receiver device of the address included in the transmission signal.

Next, a configuration of the receiver device C is described. A wireless receiver part 43 receives via an antenna 41 a transmission signal x transmitted by the transmitter device B. In addition, at the wireless receiver part 43, reception takes place in a state where signal f from an interference source has also been added. Assuming here that the complex gain of the propagation channel between the transmitter device B and the receiver device C is hs, and that the noise added at the time of SCH signal reception is n, then this is represented as

y=hs*x+f+n

The wireless receiver part 43 inputs the received signal to a frame separator part 45. The frame separator part 45 separates the inputted signal into CRS, DRS and SCH signals y, and inputs them to a CRS detector part 57, a DRS detector part 53 and a propagation channel compensation part 52, respectively.

The CRS detector part 57 inputs the received CRS to the SNR measuring part 61. The SNR measuring part 61 measures the SNR based on the inputted CRS, and notifies the transmitter device B of the SNR.

The DRS detector part 53 detects the propagation channel state using the DRS inputted from the frame separator part 45, and inputs it to the propagation channel compensation part 52. Here, since the DRS has been multiplied by 1/α at the transmitter device B, the DRS detector 53 would be estimating the propagation channel state as being hs/a. This estimated propagation channel state, hs/α, is inputted to the propagation channel compensation part 52.

At the propagation channel compensation part 52, performing propagation channel compensation on reception signal y gives y/(hs/α)=αy/hs. Assuming that the DRS has not been multiplied by α, it becomes y/hs after propagation channel compensation. By further multiplying this signal by α using a separately detected α, a signal represented as αy/hs would be calculated. In other words, this would signify that by multiplying the DRS by α, the process up to multiplying the reception signal by α may be carried out without having to separately notify α. Thus, in the present embodiment, there is no need to perform transmission with α included in the CCH, and the information volume of the CCH may be reduced.

Finally, signal αy/hs calculated at the propagation channel compensation part 52 is inputted to a reception modulo operator part 51. The reception modulo operator part 51 performs the modulo operation represented by Equation (1) above on signal αy/hs that has been inputted, and outputs estimated signal s′.

Here, at the receiver device C, the modulo operation represented by Equation (1) is performed on signal αy/hs. This would be equivalent to performing the modulo operation represented by Equation (1) after multiplying signal y/hs by coefficient α. Further, this is equivalent to performing a modulo operation on y/hs with τ/αsubstituted for modulo width r. In other words, it may be said that the fact that the transmitter device B performs ILP means that the transmitter device B alters the modulo width with respect to the receiver device C. In addition, notifying coefficient α is equivalent to notifying the altered modulo width. It may thus be said that in the present embodiment, the altered modulo width is notified by way of a DRS.

An example of a specific application of the system described above is described using FIG. 1B. FIG. 1B represents a case where, with respect to a system in which a transmitter device transmits an OFDM signal and the receiver device receives this signal, a transmission signal from another communication device (interference source) is also received as interference.

The specific example described in connection with FIG. 1B is of a scheme where each sub-carrier is independent, and the following is a description with respect to one sub-carrier. In other words, it is assumed that the propagation channel state, transmission signal, etc., correspond to a certain sub-carrier.

In the present specific example, in order for the transmitter device B to find out interference signal f, the interference source notifies the transmitter device B in advance by having transmission signal t of the interference source calculated at an interference signal calculator part 28. Further, although the receiver device C notified the transmitter device B of only the SNR in the example above, the receiver device C notifies the transmitter device of propagation channel hs between the transmission signal and the receiver device and of propagation channel state hf between the interference source and the receiver device. In other words, the receiver device C needs to estimate propagation channel hs between the transmission signal and the receiver device, and propagation channel state hf between the interference source and the receiver device. Thus, while the receiver device only measured the SNR at the SNR measuring part 61 in FIG. 1A, it now has a propagation channel estimation part 58 in FIG. 1B. In other words, it has the propagation channel estimation part 58 that estimates propagation channel state hs between the transmitter device B and the receiver device C using the CRS transmitted from the transmitter device B, and that estimates propagation channel hf between the interference source and the receiver device C based on the CRS from the interference source. The receiver device C notifies the transmitter device B of hs and hf as estimated.

In addition, using hs, hf and t, the transmitter device calculates interference signal f with the equation

f=(hf*t)/hs

Interference signal f calculated here is such that (hf*t) is divided by propagation channel hs in order to cancel signal (hf*t) that the receiver device actually receives from the interference source.

In addition, since it transmits signals in an OFDM scheme, the transmitter device has an IFFT (Inverse Fast Fourier Transform) part and a GI (guard interval) insertion part before the wireless transmitter part, and the receiver device, in correspondence thereto, has a GI removal part and an FFT (Fast Fourier Transform) part after the wireless receiver part. These parts are omitted in FIG. 1B. Apart from the above, it has the same features as the corresponding parts in FIG. 1A.

The present embodiment may be applied with respect to the system in FIG. 1B in the manner above.

### Second Embodiment

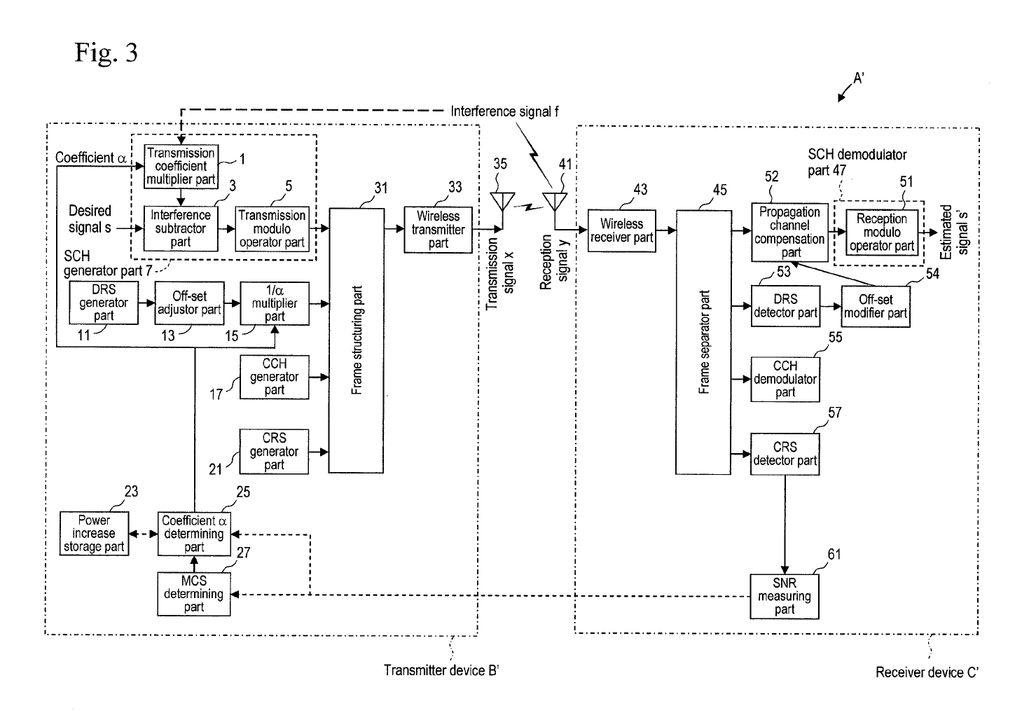

FIG. 3 is a schematic diagram showing a signal flow with respect to a wireless communication system A′ according to the second embodiment of the present invention. Parts that differ from FIG. 1A will mainly be discussed. For the conventional form and the first embodiment, cases where the transmission power of the DRS and the transmission power of the SCH for which ILP transmission is performed are equal were described. However, in a system, in order to improve the estimation accuracy for the phase and amplitude of the DRS, a method in which the transmission power is increased (off-set) in advance in known proportions at a transmitter device B′ and a receiver device C′ is sometimes used.

Here, it is assumed, hypothetically, that the DRS generator part 11 outputs the DRS with a transmission power that has been off-set by +k dB. As shown in FIG. 3, the DRS signal from the DRS generator part 11 is adjusted at an off-set adjustor part 13 so as to be attenuated by −h dB. Coefficient α determined at the coefficient α determining part 25 is inputted to the coefficient 1/α multiplier part 15, and the DRS from the off-set adjustor part 13 is multiplied by 1/α. At the receiver device C′, propagation channel estimation is performed at the DRS detector part 53 based on the detected DRS and assuming the off-set is +k dB. Thus, with respect to the correct propagation channel, the received power ends up being estimated to be lower by −h dB. An off-set modifier part 54 modifies this estimated value in such a manner that the received power of the DRS is held to be greater by an amount corresponding to −h dB. By performing propagation channel compensation at the propagation channel compensation part 52, estimated signal s′ may be obtained by performing, at the reception modulo operator part 51 which receives the output of the propagation channel compensation part 52, a remainder process using a modulo width determined from the DRS without performing the process at the reception coefficient multiplier part. Here, the DRS that has been off-set by an amount corresponding to (k−h) dB is referred to as an off-set reference signal. Here, whereas an off-set of k dB would ordinarily have been performed, an off-set of (k−h) dB is performed with respect to the DRS. In other words, a state in which the power of the DRS was lower by a predetermined power h dB is modified.

It is noted that off-set value h is discussed taking as an example a case where it is a constant value known in advance on the transmitter/receiver side. However, besides the above, the transmitter device may also alter the value of h as a control signal once per frame or once per several frames and notify the receiver device of it. By way of example, since the SNR varies from sub-carrier to sub-carrier in OFDM transmission schemes, it is assumed that the value of α varies from sub-carrier to sub-carrier. In this case, it is necessary to transmit a DRS that has been power adjusted (multiplied by 1/α) using a different a for each sub-carrier. In this case, it is necessary to transmit a plurality of DRS's within one frame. In so doing, the value of h may by altered once per frame or once per several frames through the CCH and notified to the receiver device. The value of h may thus be adaptively altered at the transmitter device from such perspectives as power consumption, etc.

A communication device according to the present invention is applicable to portable terminals, such as portable radio devices, etc., and is also applicable to television functions that PCs, etc., are equipped with.

A program that runs on a communication device according to the present invention may be a program that controls a CPU (Central Processing Unit), etc., so as to realize the functions of the embodiments above relating to the present invention (a program that enables a computer to function). Further, the information handled by these devices is temporarily accumulated in RAM (Random Access Memory) during the processing thereof, is thereafter stored on various ROM (Read Only Memory), such as flash ROM, etc., or an HDD (Hard Disk Drive), and is read/modified/written by the CPU as required.

In addition, the processes of the various parts may be performed by recording on a computer-readable recording medium a program for realizing the functions of the various features in FIG. 1A, etc., and having this program, which is recorded on the recording medium, read and executed by a computer system. It is noted that the term “computer system” as used herein is to encompass the OS, as well as hardware, such as peripheral devices, etc.

In addition, the term “computer-readable recording medium” may refer to a portable medium, such as a flexible disk, a magneto-optical disk, ROM, CD-ROM, etc., or a storage device such as a hard disk, etc., built into a computer system. Further, the term “computer-readable recording medium” is also to encompass one that dynamically holds a program for a short period of time, as in communication lines in a case where a program is transmitted over a network, such as the Internet, etc., or telecommunication lines, such as phone lines, etc., as well as one that holds a program for a given period of time, such as a volatile memory within a computer system that serves as a server or a client in such a case. In addition, the above-mentioned program may also be one for realizing a portion of the functions discussed above, and, further, it may also be one that is capable of realizing the functions discussed above in combination with a program(s) already recorded on a computer system.

Although embodiments of the present invention have thus been described in detail with reference to the drawings, specific structures are not limited to those of the embodiments, and inventions with design modifications, etc., within a scope that does not depart from the spirit of the present invention are covered as well.

### INDUSTRIAL APPLICABILITY

The present invention is suited for use hi mobile communication systems, but may also be used in fixed communication systems.

All publications, patents and patent applications cited in the present specification are incorporated herein for reference in their entirety.

1. A transmitter device in a wireless communication system in which a modulo operation is performed on a modulated signal at least one of the transmitter device and a receiver device, wherein an altered modulo width is notified by way of the amplitude of a portion of a transmission signal.

2. The transmitter device according to claim 1, wherein a portion of the transmission signal is a portion or the whole of a reference signal.

3. The transmitter device according to claim 2 wherein the reference signal is a reference signal dedicated to a receiver device of an address included in the transmission signal.

4. The transmitter device according to claim 2, wherein the altered modulo width is notified using a reference amplitude of an altered reference signal.

5. A transmitter device that transmits, to a receiver device, a transmission signal generated by subtracting the result of multiplying an interference signal, which corresponds to interference that the receiver device is subjected to, by a coefficient and by further performing a modulo operation, and a reference signal generated based on the coefficient.

6. The transmitter device according to claim 5 wherein the reference signal has an amplitude that is proportional to the inverse of the coefficient.

7. The transmitter device according to claim 5, wherein transmission is performed with the power of the reference signal attenuated by a predetermined power.

8. A receiver device that
receives a transmission signal and a reference signal that are transmitted by a transmitter device,
performs propagation channel estimation using the received reference signal DRS,
performs a modification in which a received power of the estimated propagation channel is held to be greater by a predetermined power,
based on a result of the modified propagation channel estimation, performs propagation channel compensation with respect to the received transmission signal, and
performs a modulo operation with respect to the received transmission signal that has undergone the propagation channel compensation.

9. A wireless communication system comprising:
a transmitter device that transmits, to a receiver device, a transmission signal generated by subtracting the result of multiplying an interference signal, which corresponds to interference that the receiver device is subjected to, by a coefficient and by further performing a modulo operation, and an off-set reference signal in which a reference signal generated based on the coefficient is attenuated by a predetermined power; and
the receiver device that receives the transmission signal and the off-set reference signal, performs propagation channel estimation using the received off-set reference signal, performs a modification in which a received power of the estimated propagation channel is held to be greater by the predetermined power, based on a result of the modified propagation channel estimation, performs propagation channel compensation with respect to the received transmission signal, and performs a modulo operation with respect to the received transmission signal that has undergone the propagation channel compensation.

10. The wireless communication system according to claim 9, wherein the reference signal has an amplitude that is proportional to the inverse of the coefficient.

11. A transmitter device in a wireless communication system in which a modulo operation is performed with respect to a modulated signal at one or both of the transmitter device and a receiver device, the transmitter device comprising:
a coefficient α determining part that determines a coefficient α;
a DRS generator part that generates a reference signal;
a 1/α multiplier part that multiplies the reference signal by the inverse of the coefficient α; and
an SCH generator part that generates an ILP signal based on the coefficient α.

12. The transmitter device according to claim 11, further comprising an off-set adjustor part that attenuates the power of the reference signal generated by the DRS generator part by a predetermined power.

13. A receiver device comprising:
a wireless receiver part that receives a transmission signal and a reference signal transmitted by a transmitter device;
a DRS detector part that performs propagation channel estimation using the received reference signal;
an off-set modifier part that performs a modification in which a received power of the estimated propagation channel is held to be greater by a predetermined power;
a propagation channel compensation part that performs propagation channel compensation with respect to the received transmission signal based on a result of the modified propagation channel estimation; and
a reception modulo operator part that performs a modulo operation with respect to the received transmission signal that has undergone the propagation channel compensation.

14. The transmitter device according to claim 7, wherein the transmitter device notifies the receiver device of the predetermined power.

15. The transmitter device according to claim 3, wherein the altered modulo width is notified using a reference amplitude of an altered reference signal.

16. The transmitter device according to claim 6, wherein transmission is performed with the power of the DRS attenuated by a predetermined power.
